(19) United States
(12) Patent Application Publication
(10) Pub. No.: US 2019/0069138 A1
(43) Pub. Date: Feb. 28, 2019

(54) Geographical Social Media Locator

(71) Applicants: Fady Najm, Riverside, CA (US); Joy Chamoun, West Covina, CA (US)

(72) Inventors: Fady Najm, Riverside, CA (US); Joy Chamoun, West Covina, CA (US)

(21) Appl. No.: 15/687,480

(22) Filed: Aug. 27, 2017

(51) Int. Cl. H04W 4/04; G06Q 50/00; G06F 17/30

(52) U.S. Cl. CPC H04W 4/04; G06F 17/30241; G06F 17/30061; G06Q 50/01

(57) ABSTRACT

An algorithm running on a mobile device or any electronic device with Camera, that captures only pictures and videos with location feature enabled. All pictures and videos must save geographical location. A visual map based search method, running on a mobile device or any computing device, is used to geographically locate shared friends or target entity pictures and videos.

The mobile application runs on a mobile device. The user has to create an account using email address. User has to agree to give the application access to the GPS information. The application allows capturing media (photos, videos) through the smart device camera and uploading them with location info. If no GPS information is available, no media will be captured.

User shares his media with friends and, or with public.

A visual map based search method, running on a mobile device or any computing device, is used to geographically locate shared friends or target entity pictures and videos.

The media is located on the map at the location where it was captured.

Comments, events and rating are attached to each media.

Media can be filtered on the map by different criteria.

The mobile application is built with the development suite belonged to the existing mobile devices platforms, for example IOS and Android.

1. Geographical Social Media Locator (GSML) is the only mobile application that mandates the capture and upload of any media with the location coordinates attached.
The application will not proceed to login if it is not granted the access to the GPS data.
The uploaded media is shared with the invited friends and or with the public. The viewers can add their comments and ratings.
The media is searchable geographically trough a map using mobile device or web browser where pins or shapes are displayed with specific colors to represent different groups.
At different map zoom level, the application reveals additional detailed information about the searched media.
When selecting a specific shared media the application displays it in bigger size.
At any time the application allows toggling between graphical view and list view.
